(19) United States
(12) Patent Application Publication
(10) Pub. No.: US 2016/0174669 A1
(43) Pub. Date: Jun. 23, 2016

(54) VARIABLE ORNAMENT ASSEMBLY

(71) Applicant: Mashannon Ferris, Costa Mesa, CA (US)

(72) Inventor: Mashannon Ferris, Costa Mesa, CA (US)

(21) Appl. No.: 15/054,549

(22) Filed: Feb. 26, 2016

Related U.S. Application Data
(63) Continuation-in-part of application No. 14/849,414, filed on Sep. 9, 2015.
(60) Provisional application No. 62/048,438, filed on Sep. 10, 2014.
(60) Provisional application No. 62/096,752, filed on Dec. 24, 2014.

(51) Int. Cl. A44B 99/00; A44B 13/00; F16B 35/00; A44B 17/00

(52) U.S. Cl. CPC A44B 99/00; A44B 17/0023; A44B 13/0029; F16B 35/00

(57) ABSTRACT

The inventive subject matter provides an ornament assembly comprising a fastener that is configured to simultaneously couple with an ornament and an accessory. The fastener could be configured such that the ornament could be replaced with one or more different ornaments without any damage to the fastener or ornament. Additionally or alternatively, the fastener could be configured to be removed from the accessory and coupled with a different accessory of the same or different size without any damage to the fastener or the accessory.

This application is a continuation-in-part of U.S. patent application Ser. No. 14/849,414 filed on Sep. 9, 2015, which claims priority to U.S. provisional patent application No. 62/048,438 filed on Sep. 10, 2014, and 62/096,752 filed on Dec. 24, 2014. These and all other extrinsic materials identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is ornament assemblies.

### BACKGROUND

The background description includes information that may be useful in understanding the present invention. It is not an admission that any of the information provided herein is prior art or relevant to the presently claimed invention, or that any publication specifically or implicitly referenced is prior art.

Some efforts have been placed in providing decorative items that can be placed on accessories such as eyeglasses. For example, U.S. Pat. No. 7,591,554 teaches a removable eyeglass charm. However, the '554 patent's charm includes a fastener that is integral with the charm, and thus the charm and fastener must be removed and replaced together. Furthermore, the fastener is apparently only suitable for coupling the charm with an arm of eyewear, and not for other accessories having different dimensions.

Thus, there is still a need for improved ornament assemblies.

### SUMMARY OF THE INVENTION

The inventive subject matter provides an ornament assembly comprising a fastener that is configured to simultaneously couple with an ornament and an accessory. In some embodiments, the fastener could be configured such that the ornament could be replaced with one or more different ornaments, preferably without any damage to the fastener or ornament. Additionally or alternatively, the fastener could be configured to be removed from the accessory and coupled with a different accessory of the same or different size, again preferably without any damage to the fastener or the accessory.

Some contemplated fasteners include a magnet that is partially or completely enclosed in an enclosure material such as silicone rubber. It should be appreciated that the casing or enclosure material could comprise silicone, rubber, plastic, or any suitable material, but is preferably thin (e.g., less than 200% the thickness of the magnet, less than 150% the thickness of the magnet, less than 100% the thickness of the magnet) to allow the fastener to magnetically couple with the ornament.

A fastener could also include an attachment mechanism that is sized and dimensioned to receive at least a portion of one or more accessories such as eyewear arms, belts and bracelets. The magnet could be used to provide a magnetic coupling with one or more ornaments such as bottle caps, jewelry ornaments, or any other suitable ornamental object made at least in part of a ferromagnetic material.

Viewed from another perspective, the inventive subject matter provides a variable ornament assembly comprising a fastener (e.g., a magnet), at least one ornament (e.g., a cap) that removably couples with the fastener, and an attachment mechanism that removably couples the fastener to an accessory (e.g., an eyeglass stem or arm). As used herein, an object that “removably couples” to another object does so in a non-destructively removable manner.

In some aspects of the inventive subject matter, the fastener is a disc-shaped magnet and includes a through-hole (e.g., radially) sized and dimensioned to receive the attachment mechanism. In a preferred embodiment, the ornament comprises a first material (e.g., a ferromagnetic metal), and the fastener and ornament can be magnetically coupled with one another. Additionally or alternatively, the attachment mechanism includes or forms one or more loops, which includes a first end, a central portion and a second end. Preferably, the first and second ends are each sized and dimensioned to receive at least a portion of an accessory when the central portion is disposed within the through-hole.

The through-hole can have any diameter suitable for receiving a suitable attachment mechanism. For example, a diameter of a through-hole can be between 0.5 mm and 20 mm, between 0.5 mm and 10 mm, between 0.5 mm and 5 mm, and most preferably between 1 mm and 3 mm. Where the magnet is at least partially enclosed in a casing, the magnet and the casing could comprise a through-hole. For example, the attachment mechanism can comprise a casing that partially or entirely encloses the fastener (e.g., magnet), and two loop ends extending from the casing.

In an alternative embodiment, the casing and magnet could lack a through-hole and the casing could include or be coupled to one or more loops sized and dimensioned to receive an accessory.

All attachment mechanisms suitable for removably coupling the fastener to any suitable accessory (e.g., eyewear, bracelet, belt, shoelace, etc.) are contemplated. In some contemplated embodiments, an attachment mechanism is a looped band or loop, for example an elastic or inelastic band. Where the attachment mechanism is disposed through a hole of the fastener, it is generally preferred that the portion of the attachment mechanism passing through a fastener's through-hole has a diameter that is no more than 125%, more preferably no more than 120%, or even more preferably no more than 110% of the thickness of the attachment mechanism.

An ornament of the inventive subject matter can be made of any suitable material(s). Where a fastener comprises a magnet (in whole or in part), it is preferred that the ornament comprises a ferromagnetic material (in whole or in part) to allow for a magnetic coupling of the ornament to the fastener. For example, the ornament could be a metal cap (e.g., a bottle cap).

The inventive subject matter also provides an ornament assembly comprising a fastener and an ornament. In some preferred embodiments, the fastener comprises a first coupling and the ornament comprises a second coupling. The first a second couplings are preferably paired such that they removably couple to one another. The first and second couplings could cooperate to act as any commercially suitable fastener, including for example snaps, buttons and button hole, screw and thread, spring-loaded detent, hook-and-loop, peg and slot, or a latch. In some embodiments, one or both of the fastener and the ornament could additionally or alternatively comprise a magnet.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1A-1C illustrate an embodiment of an ornament assembly.

FIGS. 2A-2B illustrate the fastener of the ornament assembly of FIGS. 1A-1C.

FIGS. 3A-3B illustrate some exemplary fasteners of the inventive subject matter.

FIGS. 4A-4D illustrate some exemplary ornaments of the inventive subject matter.

FIGS. 5A-5B illustrate the ornament assembly of FIGS. 1A-1C on an accessory.

FIG. 6 illustrates the ornament assembly of FIGS. 1A-1C on another accessory.

FIGS. 7A-7D illustrate another fastener of the inventive subject matter.

FIG. 8 illustrates the fastener of FIGS. 7A-7D on an accessory.

FIGS. 9A-9B illustrate another ornament of the inventive subject matter, which could be used with a fastener of the inventive subject matter.

FIGS. 10A-10B illustrate some exemplary fasteners of the inventive subject matter having male snap-couplers.

FIG. 11 illustrates an exemplary ornament of the inventive subject matter having a female snap-coupler.

FIGS. 12A-12B illustrate some exemplary fasteners of the inventive subject matter having a loop component of a hook and loop fastener.

FIG. 13 illustrates an exemplary ornament of the inventive subject matter having a hook component of a hook and loop fastener.

FIGS. 14A-14B illustrate some exemplary fasteners of the inventive subject matter having female screw couplers.

FIG. 15 illustrates an exemplary ornament of the inventive subject matter having a male screw coupler.

FIG. 16 illustrates an exemplary fastener of the inventive subject matter having a male snap-coupler.

FIG. 17 illustrates an exemplary fastener of the inventive subject matter having a hook component of a hook and loop fastener.

FIG. 18 illustrates an exemplary fastener of the inventive subject matter having a male screw coupler.

FIGS. 19A-C illustrate exemplary fasteners configured to couple with the ornaments shown in FIGS. 20A-C.

FIGS. 20A-C illustrate exemplary ornaments configured to couple with fasteners shown in FIGS. 19A-C.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

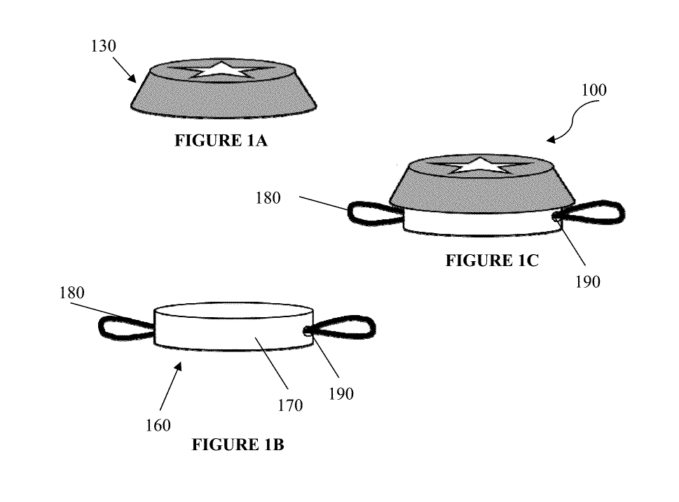

FIGS. 1A-1C shows an embodiment of a variable ornament assembly 100 of the inventive subject matter having an ornament 130 and a fastener 160. Here, fastener 160 comprises a magnet 170, an attachment mechanism 180, and a through-hole 190 sized and dimensioned to receive the attachment mechanism 180. The ornament 130 comprises a material (that may or may not be different than the material of the fastener—e.g., a magnet, a metal) that allows for a magnetic coupling of the ornament and the magnet. As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, it is contemplated that the magnet 170 could be partially or fully enclosed in a casing as further described below. The casing may or may not be magnetic or ferromagnetic and may comprise plastic, wood, leather, metal, ceramic, glass, rubber, silicone, silicone rubber, or another commercially suitable material(s). The casing could act as a buffer to reduce or control the magnetic attraction between the magnet and an ornament or other object.

As used herein, a magnet can partially or fully comprise a permanent or a temporary magnet. Permanent magnets partially or fully comprise a ferromagnetic metal or ferromagnetic metal alloy, such as nickel, iron, neodymium, magnetite, steel, aluminum-nickel-cobalt, neodymium-iron-boron, samarium-cobalt, strontium-iron, or any other ferromagnetic metal or ferromagnetic alloy. Temporary magnets include electromagnets, solenoids, or other magnets that are magnetized by a magnetic field produced by an electric current.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

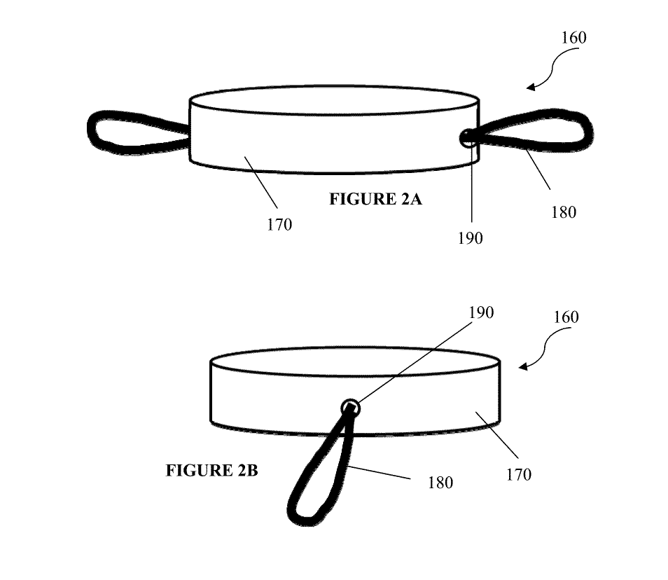

FIGS. 2A-2B provide further views of fastener 160. Fastener 160 comprises a magnet 170, an attachment mechanism 180, and a through-hole 190. The through-hole 190 is sized and dimensioned to receive the attachment mechanism 180. In some contemplated embodiments, contemplated fasteners could additionally or alternatively comprise a partial hole or recess that extends only partially through a dimension of the magnet. Alternatively or additionally, a partial or through-hole can extend partially or completely through a dimension of a casing (where included). It should also be appreciated that a fastener of the inventive subject matter can include a plurality of partial holes or through-holes.

In some embodiments, the partial hole(s) or through-hole(s) can have a diameter of between 0.5 mm and 5 mm, inclusive, more preferably between 1 mm and 4 mm, inclusive, and most preferably between 2 mm and 3 mm, inclusive. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used herein, a “hole” includes any aperture, opening, gap, space, indentation, or perforation that is sized- and dimensioned to receive at least a portion of an attachment mechanism.

In some embodiments, a fastener could includea casing that encloses a magnet, and includes one or more looped portions that are sized and dimensioned to receive an accessory. The attachment mechanisms (e.g., looped material, etc.) can be composed of different materials with different thicknesses depending on the contemplated ornament(s) and accessory. In preferred embodiments, the thickness of a portion of the attachment mechanism that passes through or within a hole of a fastener—in relation to a diameter of the hole—is preferably at least 0.75:1, more preferably at least 0.85:1, and most preferably at least 0.90:1. Viewed from a different perspective, where a diameter of a fastener hole is 5 mm, it is generally preferred that the portion of an attachment mechanism (e.g., rubber band) that passes through the hole has a thickness that is at least 3.75 mm, more preferably at least 4.25 mm, and most preferably at least 4.5 mm. In some embodiments, for example where the attachment mechanism comprises a looped material, it is contemplated that the “thickness” of the portion passing through a fastener hole would be twice as large as a thickness of the same material if unlooped.

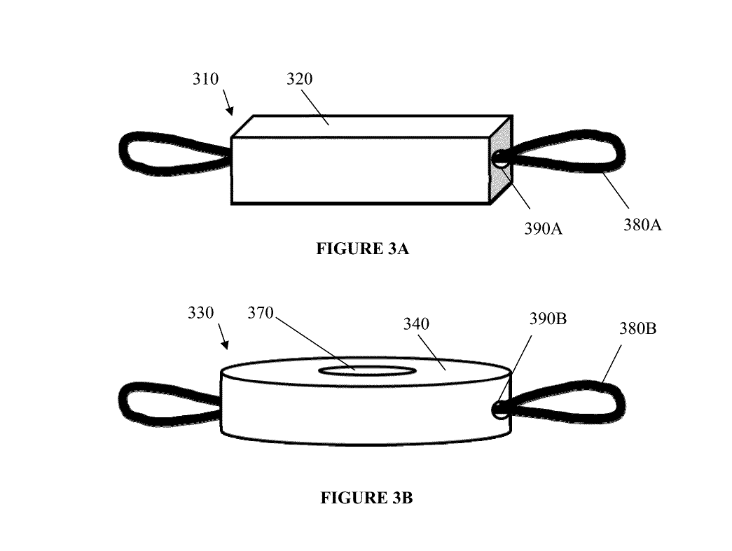

A fastener of the inventive subject matter could comprise any suitable regular or irregular shape, including for example, a cylinder (e.g., a disc), a sphere, a cube, a tetrahedron, a trapezoidal prism, etc. For example, FIG. 3A shows a rectangular cube-shaped fastener 310 comprising a magnet 320, an attachment mechanism 380A, and a through-hole 390A. FIG. 3B shows a disc-shaped fastener 330 with a small magnet 370 partially enclosed or encased in a casing 340 with a through-hole 390B extending through the magnet and the casing, and an attachment mechanism 380B. As shown in FIG. 3B, the through-hole may extend radially through a diameter of the fastener.

In some embodiments, the attachment mechanism can be a part of a casing that partially or entirely encloses the fastener. For example, the attachment mechanism could comprise two loops that are a part of, and extend from, the casing. Such an embodiment may be advantageous as it could simplify manufacturing by eliminating the need for a through-hole. Also, this embodiment could reduce the number of parts required by incorporating the attachment mechanism as part of the casing. It is contemplated that the casing can comprise silicone, plastic, rubber, nylon, or any other suitable material that is of sufficient thinness to allow the magnet enclosed to fasten with an ornament.

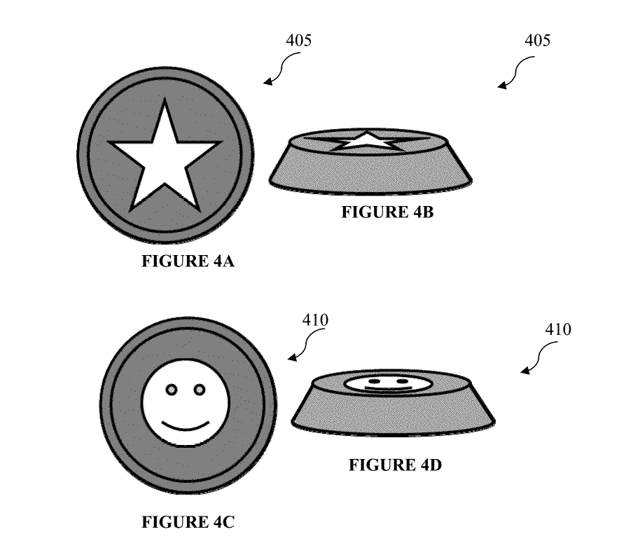

In FIGS. 4A-4D, two ornaments 405 and 410 are shown having different designs. Ornaments 405 and 410 are made at least in part of a metal that is ferromagnetic. However, it should also be appreciated that fasteners and ornaments could removably couple to one another in any suitable manner. For example, the fastener and ornament could comprise complementary hook and loop fasteners, snaps, button and buttonhole, or any other suitable coupling mechanisms.

Ornaments 405 and 410 are caps, and could be made of a plastic, a ceramic, a wood, a metal, a leather, a fabric, or any other commercially suitable material(s). A plurality of ornaments with a plurality of designs could be provided and used with the same fastener, which could allow the user to change a design of an assembly by switching out an ornament as desired. As used herein, the term “design” includes any drawing, sketch, pattern, motif, diagram, picture, photo, logo, character, letter, etc. and may be etched or drawn directly on the ornament or may be attached via adhesive means (e.g. a sticker). As used herein, the term “ornament” should be interpreted broadly to include, among other things, a charm, a bauble, a trinket, a decoration, an adornment, an embellishment, or other suitable item.

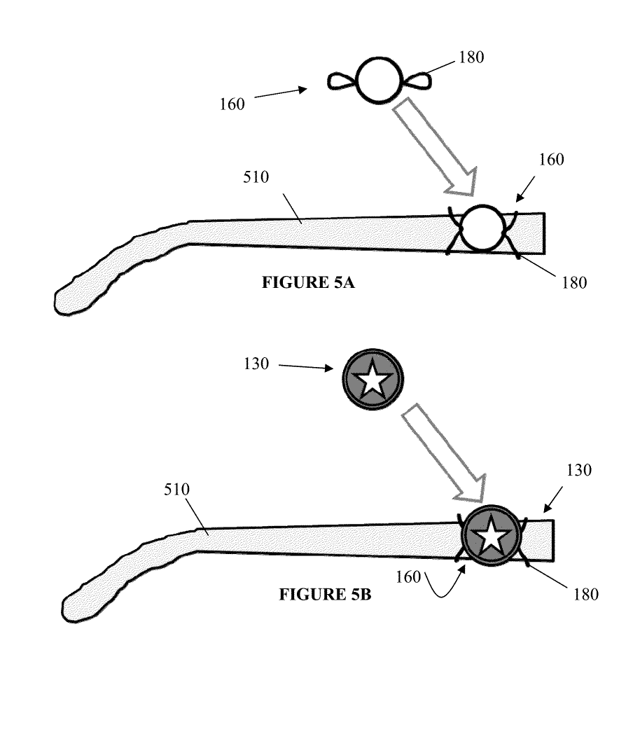

FIGS. 5A-5B illustrate a fastener being attached to an accessory, and an ornament being placed on the fastener. Here, fastener 160 is attached to the accessory, in this case an arm 510 of a pair of glasses, via attachment mechanism 180. In embodiments where attachment mechanism is looped, arm 510 can extend through the loops of attachment mechanism 180. In some other contemplated embodiments, attachment mechanism 180 may be tied to arm 510. Ornament 130 can be magnetically attached to fastener 160, and may be removed and replaced with another ornament of a different color, dimension, shape, or design without removing fastener 160 from arm 510.

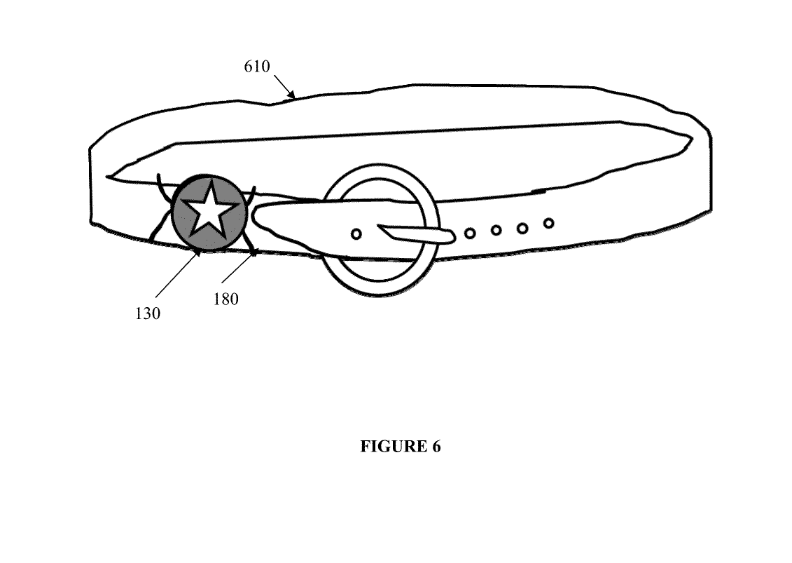

As used herein, an accessory includes any article or item that can be carried or worn, for example, to complement a garment or outfit. Contemplated accessories include, but are not limited to eyewear, bracelets, necklaces, earrings, belts, scarves, shoelaces, shoes, tools, frames, furniture items (e.g., lamps, tables, chairs), cables, writing utensils, pet collars, and bags (e.g., tote bags, cross-body bag straps, backpacks). For example, FIG. 6 illustrates an ornament assembly having an ornament 130, a fastener (not shown) and attachment mechanism 180 coupled to a belt.

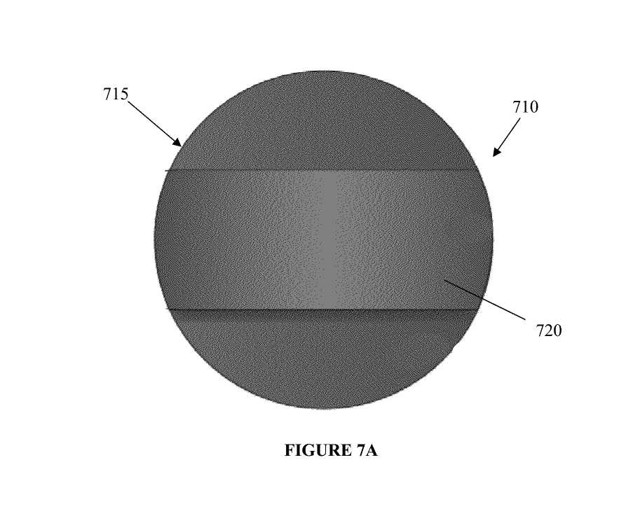

FIGS. 7A-7D illustrate another contemplated fastener of the inventive subject matter, which could be used with any suitable ornaments and accessories as described above and below.

Fastener 710 includes a magnet 730 that is completely enclosed in a casing 715. Casing 715 is coupled with a looped portion 720 such that the casing and looped portion define an opening sized and dimensioned to receive one or more accessories. In some preferred embodiments, the casing is made of a silicone, a rubber, or a silicone rubber, and is at least partially elastic to accommodate accessories of different sizes and shapes. Additionally or alternatively, the casing and the looped portion could be made of a single piece of material. Additionally or alternatively, the casing could comprise an aperture through which the magnet 730 could be received.

Magnet 730 is disc-shaped, and could have any suitable thickness and diameter. For example, the magnet could have a thickness of greater than 10 mm, greater than 15 mm, greater than 20 mm, less than 15 mm, less than 10 mm, less than 5 mm, between 1-25 mm, between 3-15 mm, between 3-5 mm, or any other suitable thickness. Additionally or alternatively, the magnet could have a diameter of greater than 20 mm, greater than 25 mm, greater than 30 mm, less than 25 mm, less than 20 mm, less than 15 mm, between 1-50 mm, between 10-20 mm, between 13-17 mm, or any other suitable diameter. Additionally or alternatively, the magnet could have a diameter to thickness ratio of between 1:1 and 1:5, between 5:1 and 1:1, between 4:1 and 2:1, or between 3.5:1 and 2.5:1, or any other suitable ratio. It is contemplated that the shape, size and dimensions could vary depending on the size and shape of the ornament, the size and shape of the ornament's fastener receiving portion or the size and shape of the accessory to be received by the attachment mechanism. Viewed from another perspective, a magnet for use with fastener 710 does not need to be disc-shaped, and could comprise any suitable shape (e.g., spherical, triangular prism, rectangular prism, an ellipsoid).

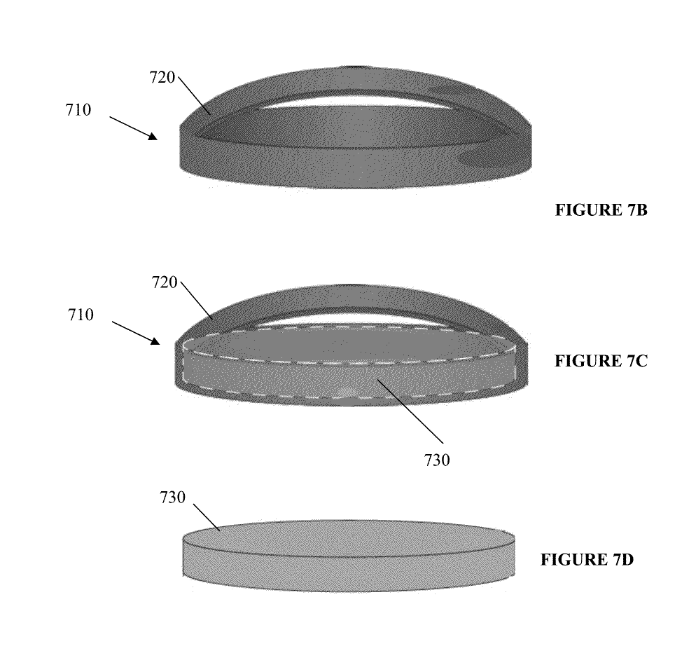

FIG. 8 illustrates fastener 710 coupled to an arm 800 of a pair of eyeglasses. In some embodiments, fastener 710 could be sized and dimensioned to alternatively or additionally couple with one or more other accessories.

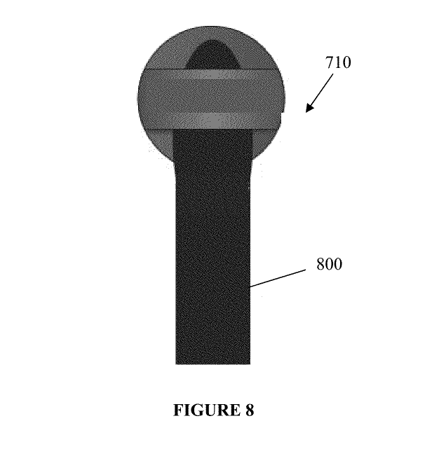

FIGS. 9A-9B illustrate an ornament 900 that could be used in conjunction with fastener 710 (or any other suitable fastener as described herein), which includes decorative elements 910 and a fastener accepting portion 920, here a disc-shaped recess. It should be appreciated that the fastener accepting portion 920 could be sized and dimensioned to partially or entirely extend over the side-wall(s) of the fastener. Viewed from another perspective, the disc-shaped recess could have a depth that is less than, equal to or greater than the width of the fastener enclosure.

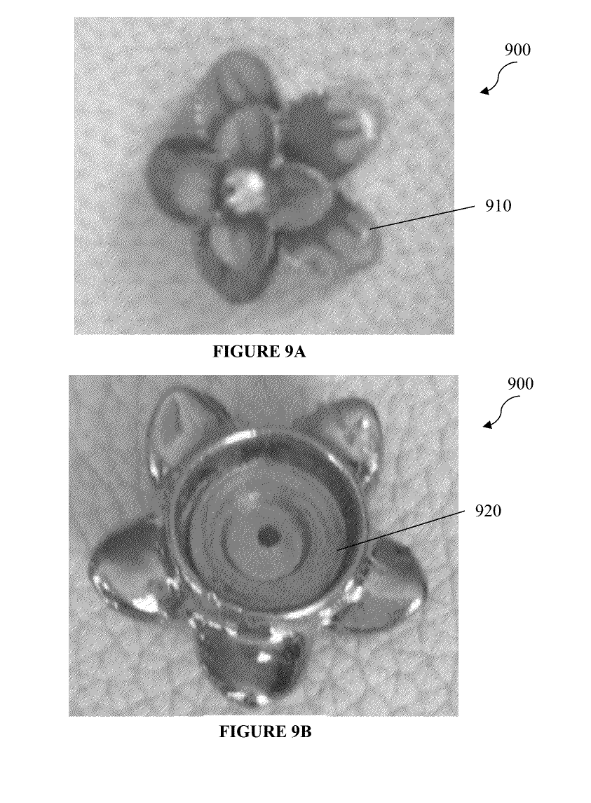

FIGS. 10A-10B illustrates fastener systems 1060 and 1070, each comprising a male snap 1010A, 1010B, a fastener body 1040, 1050, an attachment mechanism 180A, 180B, and a through-hole 190A, 190B through which the attachment mechanism extends through. Attachment mechanisms 180A, 180B and through holes 190A, 190B can be configured as described with respect to attachment mechanism 180 and through hole 190 above. A distinction between fastener systems 1060 and 1070 is the shape of their respective fastener bodies. Fastener body 1040 of fastener system 1060 is shaped as a cylinder while fastener body 1050 of fastener system 1070 is shaped as a rectangular prism. It should be appreciated that fastener bodies 1040 and 1050 can have a variety of three-dimensional shapes, including elliptic cylinder, parabolic cylinder, hyperbolic cylinder, polygonal prism, or any other commercially suitable shape.

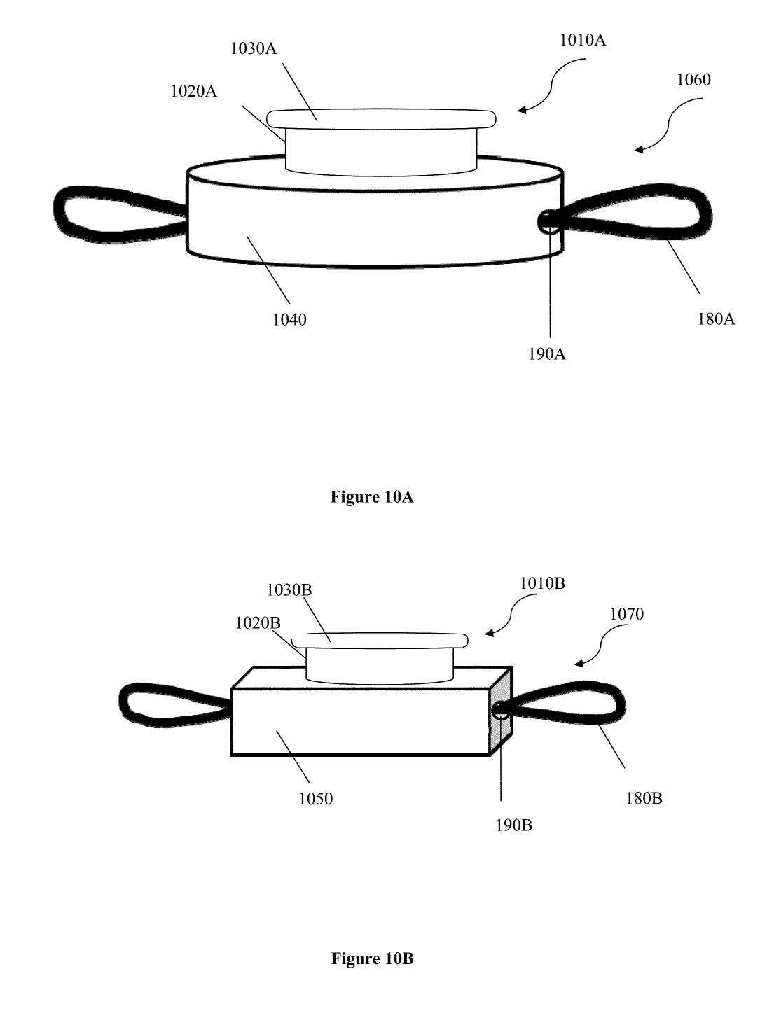

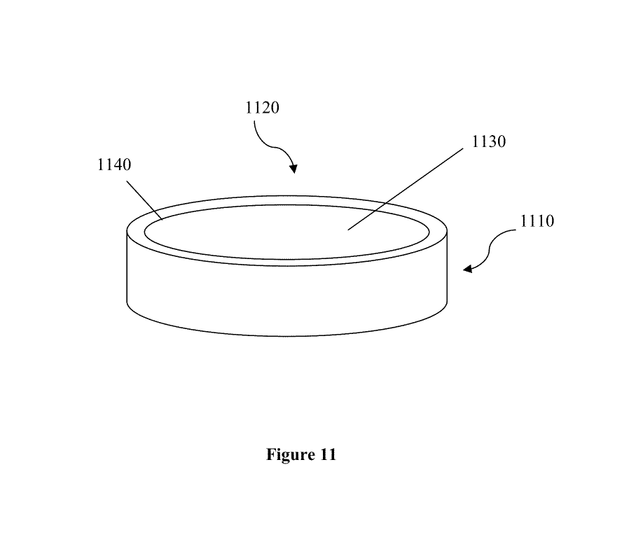

Male snap 1010A comprises stem 1020A and lip 1030A, and is configured to couple with female snap couplings, such as the female snap coupling 1120 depicted in FIG. 11. Male snap 1010B comprises stem 1020B and lip 1030B, and is also configured to couple with female snap coupling 1120 of ornament 1110. While FIGS. 10A-10B depict male snap couplings and FIG. 11 depicts female snap couplings, it should be appreciated that other configurations suitable for removably coupling the fastener to an ornament can be used alone or in combination, such as button snaps, buttons and button hole, screw and thread, spring-loaded detent, hook-and-loop, peg and slot, and latch and recess. It is also contemplated that the coupling on the fastener and the coupling on the ornament (i.e. male on fastener, female on ornament) as described throughout can be switched. Further, it is contemplated that magnetic fasteners such as those described in FIGS. 1A-3B and 7A-8 can be used in combination with the couplings described above. The same is true for the embodiments depicted in FIGS. 12A-18.

FIG. 11 illustrates ornament 1110 having female snap coupling 1120. Female snap coupling 1120 comprises recess 1130 and lip 1140. Recess 1130 is sized and dimensioned to receive a male snap coupling, such as male snap coupling 1010 in FIGS. 10A-10B. Lip 1140 is sized and dimensioned to couple with lip 1030 of FIGS. 10A and 10B such that pressing male snap coupling into female snap coupling flexes the interface between lip 1030 and 1140 until lip 1030 passes lip 1140 and male snap coupling is received into recess 1130.

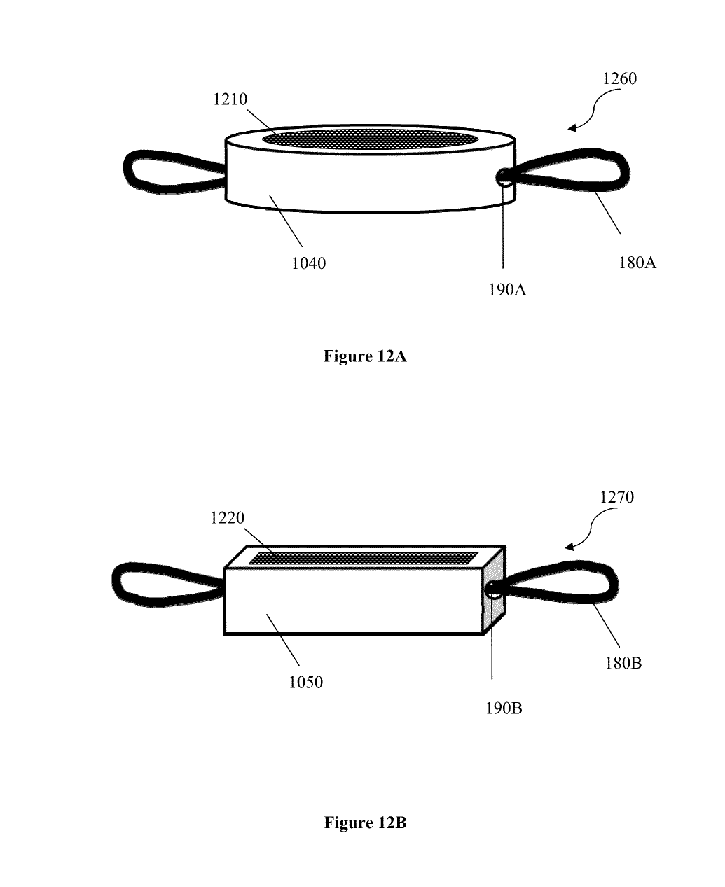

FIGS. 12A-12B depict additional contemplated fastener systems of the inventive subject matter. Similarly numbered elements have the same description as above for FIGS. 10A and 10B. A distinction between fastener systems 1060 and 1070 of FIGS. 10A-10B and fastener systems 1260 and 1270 of FIG. 12A-12B is loop couplings 1210 and 1220. Loop couplings 1210 and 1220 comprise the loop component of hook-and-loop couplings. Fastener systems 1260 and 1270 could additionally or alternatively comprise hook couplings. Loop couplings 1210 and 1220 are illustrated as circular and rectangular in shape, respectively, but can be of any suitable geometric shape. Loop couplings 1210 and 1220 are configured to mate with hook couplings, such as hook coupling 1320 of ornament 1310 of FIG. 13.

FIG. 13 depicts ornament 1310 comprising hook coupling 1320, which is configured to removably couple with loop couplings 1210 and 1220. Ornament 1310 could additionally or alternatively comprise loop couplings. Viewed from another perspective, the configuration of fasteners 1260 and 1270 with respect to ornament 1310 (i.e. loop coupling versus hook coupling) can be switched.

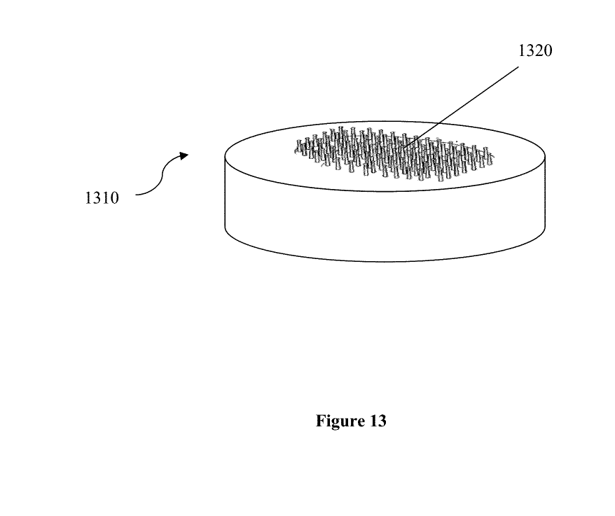

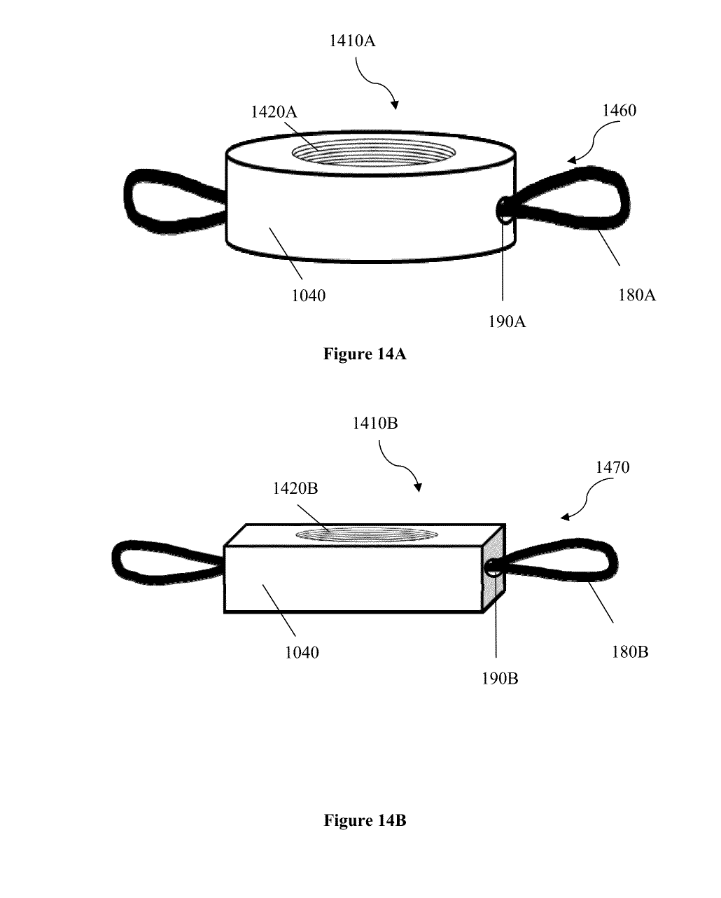

FIGS. 14A-14B depict fastener systems 1460 and 1470 comprising threaded recesses 1410A and 1410B, respectively. Similarly numbered elements have the same description as above for FIGS. 10A and 10B. Threaded recess 1410A comprises female threads 1420A that are sized and dimensioned to mate with male threads 1540 of a screw or bolt, such as screw or threaded element 1520 of ornament 1510 (FIG. 15). Threaded recess 1410B similarly comprises female threads 1420B that are sized and dimensioned to mate with male threads 1540 of threaded element 1520 of ornament 1510.

FIG. 15 depicts ornament 1510 comprising threaded element 1520. Threaded element 1520 comprises stem 1530 having spiraled ridges or male threads 1540 disposed along the circumference of stem 1530. Male threads 1540 are sized and dimensioned to mate with female threads 1420 or threaded recess 1410.

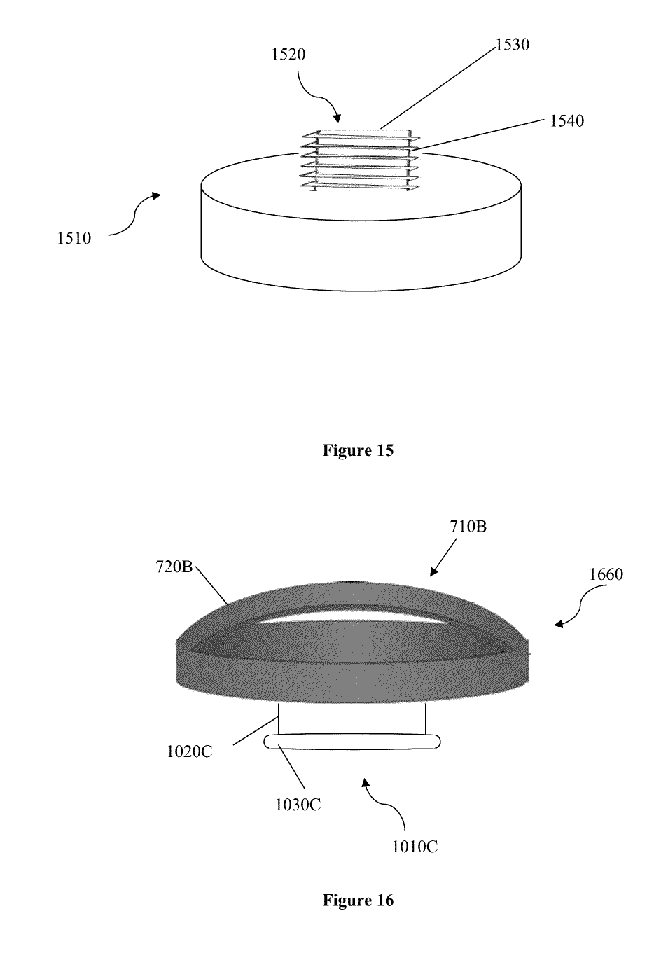

FIG. 16 depicts fastener system 1660 having a male snap coupling 1010C, and a fastener 710A with loop portion 720B. Male snap coupling 1010C comprising a stem 1020C and lip 1030C, similarly to male snaps 1010A and 1010B of FIGS. 10A-10B. It should be appreciated that fastener 710B could be the same as, or similar to fastener 710 of FIGS. 7A-7D, with or without a magnet (e.g., 730). Additionally or alternatively, it is contemplated that a head of male snap 1010C could be partially or entirely disposed within fastener 710B's casing (similar to casing 715). Additionally or alternatively, it is contemplated that male snap 1010C could be coupled with fastener 710B's casing in any suitable manner. Additionally or alternatively, it is contemplated that loop portion 720B could be coupled directly to male snap 1010C, or to a material attached to snap 1010C. Viewed from another perspective, fastener 710B does not need to include a casing, for example, where fastener 710B does not include a magnet to encase.

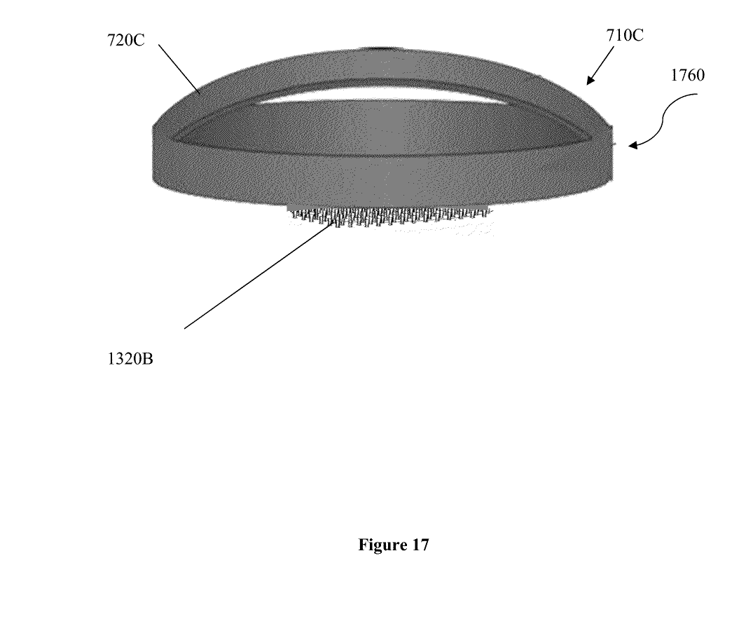

FIG. 17 depicts fastener system 1760 having a hook coupling 1320B, and a fastener 710C, which includes a casing and loop portion 720C. Fastener system 1760 could couple with an ornament having a hook or loop fastener, such as ornament 1310 of FIG. 13.

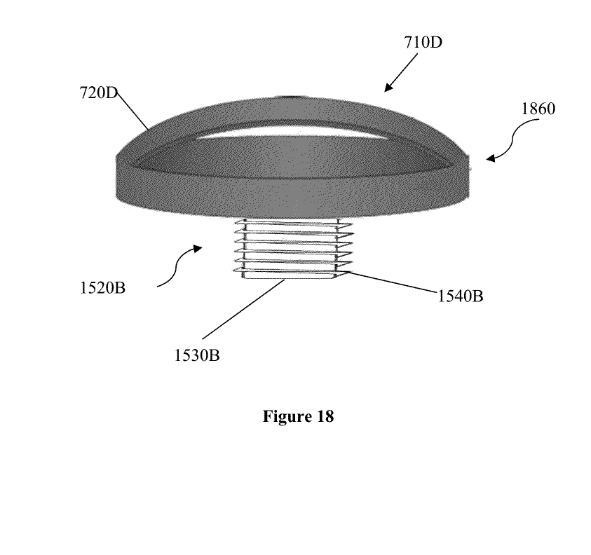

FIG. 18 depicts fastener system 1860 having a threaded element 1520B, and fastener 710D. Threaded element 1520B includes a stem 1530B and male threads 1540B, and fastener 710D includes a casing and a loop portion 720. Fastener system 1860 could couple with an ornament having a complementary threading, such as an ornament having a threaded recess with female threads.

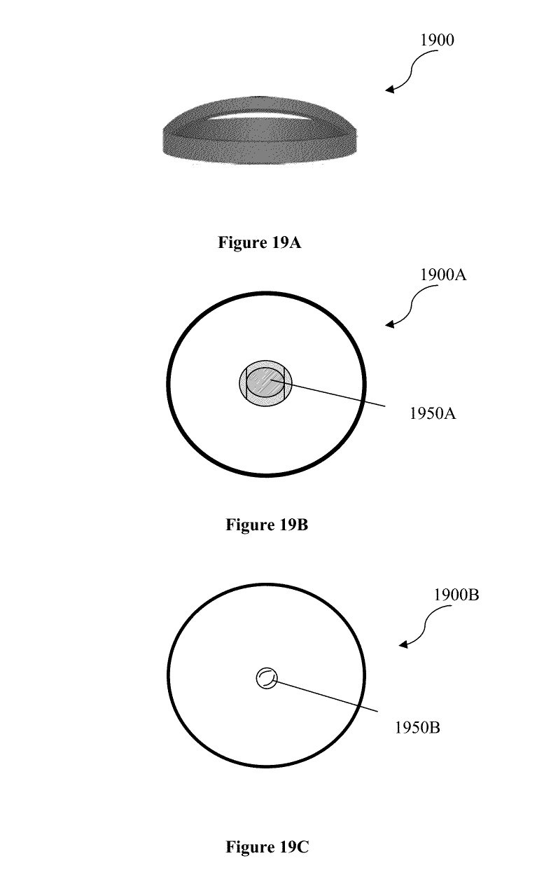

FIGS. 19A-C illustrate fastener systems 1900A, 1900B, and 1900C. Each of the fasteners include a casing (as best illustrated in FIG. 19A) that is coupled to or includes a band. The band is preferably made of at least one of a silicon and a rubber, and is sized and dimensioned to receive one or more accessories, such as an arm of a pair of glasses.

The casing could be made of one or more materials. For example, the casing could include a metal or plastic face portion (opposite the band) as illustrated in FIGS. 19B and 19C, where a snap acceptor (e.g., 1950A) or recessed internal threading (e.g., 1950B) could be included. The remaining portions of the casing could be made of, for example, metal, plastic, silicon, rubber, or any other suitable materials.

In some embodiments, a silicon or rubber casing could partially enclose a cylindrical or other shaped piece that is made of a plastic or a metal, for example, and includes a snap acceptor or an internal threading. For example, the casing could enclose the entire metal or plastic piece having the snap acceptor, threading or other coupler, except the face portion that includes the snap acceptor or internal threading that couples with a coupling of an ornament.

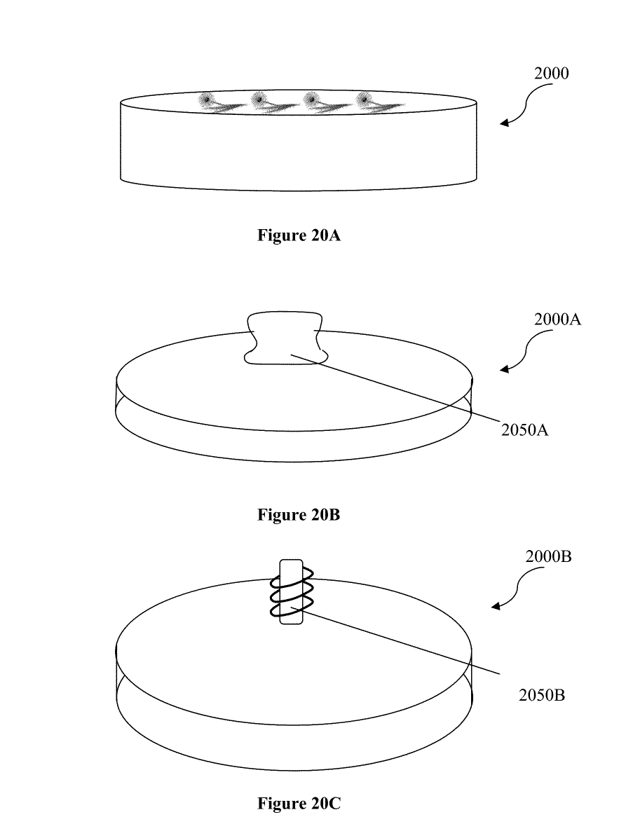

FIGS. 20A-C illustrate ornaments 2000, 2000A, and 2000B. Each of the ornaments includes an ornamental design on a design face, and includes a coupling on a coupler face. In FIG. 20A, the design face is shown, and the coupler face is not shown. In FIG. 20B, the design face is facing down and hidden, and coupler face including a snap coupling 2050A is shown in FIG. 20C, the design face is facing down and hidden, and coupler face including a threaded coupling 2050B is shown.

It should be appreciated that snap coupling 2050A could be sized and dimensioned to snap into snap acceptor 1950A of FIG. 19B, and threaded coupling 2050B could be sized and dimensioned to thread with internal threading 1950B. When snap coupling 2050A is coupled with snap acceptor 1950A, it is contemplated that snap coupling 2050A could be entirely disposed within snap acceptor 1950A such that the fastener system and ornament are adjacent one another. When threaded coupling 2050B is coupled with internal threading 1950B, it is contemplated that threaded coupling 2050B could be entirely disposed within internal threading 1950B such that the fastener system and ornament are adjacent one another.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An ornament assembly, comprising:
a fastener system comprising a first coupling coupled to an attachment mechanism, wherein the attachment mechanism is (a) sized and dimensioned to receive at least a portion of a first accessory, and (b) comprises a looped material;
a first ornament comprising a second coupling; and
wherein the first coupling is configured to removably couple with the second coupling.

2. The assembly of claim 1, wherein the first coupling comprises a hook or loop fastener.

3. The assembly of claim 1, wherein the first coupling comprises at least one of a snap coupling and a snap acceptor.

4. The assembly of claim 1, wherein the first coupling comprises at least one of a threaded coupling and an internal threading.

5. The assembly of claim 1, wherein the first coupling comprises a magnet disposed in an enclosure coupled to the attachment mechanism.

6. The assembly of claim 1, wherein the fastener system further comprises a magnet at least partially disposed in a first enclosure.

7. The assembly of claim 1, wherein the fastener system further comprises a silicon enclosure that includes the looped material, and wherein the first coupling comprises at least one of a plastic and a metal that is partially encased in the silicon enclosure.

8. The assembly of claim 1, wherein the ornament comprises a magnetic material.

9. The assembly of claim 3, wherein the first coupling comprises a snap receiver, and wherein the second coupling comprises a snap coupling.

10. The assembly of claim 4, wherein the first coupling comprises an internal threading including female threads, and wherein the second coupling comprises a threaded coupling including male threads.

11. An ornament assembly, comprising:
a fastener having a first coupling and a through-hole sized and dimensioned to receive at least a portion of an attachment mechanism;
a first ornament comprising a second coupling;
wherein the fastener and first ornament are removably coupled with one another via the first and second couplings; and
wherein the attachment mechanism comprises a first loop having a first end, a second end and a central portion, and wherein the first and second ends are each sized and dimensioned to receive at least a portion of an accessory when the central portion is disposed in the through-hole of the fastener.

12. The assembly of claim 11, wherein the fastener further comprises a magnet.

13. The assembly of claim 11, wherein the first coupling comprises a portion of a hook-and-loop fastener.

14. The assembly of claim 11, wherein the first coupling comprises a portion of a snap fastener.

15. The assembly of claim 11, wherein the first coupling comprises a portion of a screw fastener.
